(19) United States
(12) Patent Application Publication
(10) Pub. No.: US 2006/0279858 A1
(43) Pub. Date: Dec. 14, 2006

(54) DLP PROJECTION APPARATUS

(76) Inventor: Chu-Ming Cheng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,867

(22) Filed: May 17, 2006

(30) Foreign Application Priority Data
May 26, 2005 (TW) 94117189

(51) Int. Cl. G02B 5/04

(52) U.S. Cl. 359/833

(57) ABSTRACT

A DLP apparatus including an illumination system, a projection lens and a DMD is provided. The illumination system is adapted for providing an elliptic light beam, and the DMD is disposed between the illumination system and the projection lens. The DMD has a plurality of micro-mirrors, each of the micro-mirrors being adapted for swinging within an angle of for allowing the elliptic light beam moving along with an extending direction of a short axis of the elliptic light beam. When the elliptic light beam is transmitted to the projection lens, a length of a long axis of the elliptic light beam is larger than a value M and a length of the short axis of the elliptic light beam is smaller than the value M. The value M is a diameter of an aperture corresponding to f-number of the aperture being ½ sin θ.

### CROSS-REFERENCE TO RELATED APPLICATION

This application claims the priority benefit of Taiwan application serial no. 94117189, filed on May 26, 2005. All disclosure of the Taiwan application is incorporated herein by reference.

### BACKGROUND OF THE INVENTION

1. Field of the Invention

The present invention relates to a projection apparatus, and particularly to a digital light processing (DLP) projection apparatus.

2. Description of Related Art

Referring to FIG. 1, a conventional DLP apparatus includes an illumination system 110, a projection lens 120 and a digital micro-mirror device (DMD) 130. The illumination system 110 at least includes a light source 112 and a relay lens 114. The light source 112 is adapted for providing a round light beam 112a. All of the relay lens 114, the projection lens 120 and the DMD 130 are secured on an optical path of the round light beam 112a. The DMD 130 is disposed between the illumination system 110 and the projection lens 120. The relay lens 114 is disposed between the light source 112 and the DMD 130.

According to the foregoing DLP apparatus 100, the relay lens 114 is adapted for projecting the round light beam 112a provided by the light source 112 to the DMD 130. The DMD 130 includes a plurality of micro-mirrors (not shown), wherein each of the micro-mirrors can be respectively at ON status, FLAT status or OFF status. A micro-mirror at ON status can transfer the round light beam 112a to the projection lens 120, and a micro-mirror at OFF status 132 can make the round light beam 112a deviated from the projection lens 120. A part of the round light beam 112a reflected from the DMD 130 to the projection lens 120 through the projection lens 120 projects an image on a screen 300.

FIG. 2 is a diagram illustrating the position relationship of the round light beam of a micro-mirror of a conventional DMD respectively at different statuses. Referring to FIG. 2, the round light beam incident to the DMD 130 is A; the round light beam at ON status is B; the round light beam at FLAT status is C; and the round light beam at OFF status is D. According to the conventional DLP apparatus 100, in order to avoid an overlap of the round light beams A and B that causes reduction of an image contrast, a distance between the projection lens 120 and the relay lens 114 is usually retained to assure that the round light beams A and B are not overlapped.

However, because of the certain distance retained between the projection lens 120 and the relay lens 114, a deviation of the projected image 80 projected from the DLP apparatus 100 may occur (as shown in FIG. 3), wherein the deviation may even be larger than 100%. Herein, the deviation is {[(½)P1+P2]/P1}×100%, wherein P1 represents a length of the image 80 at the X-axis direction and P2 represents the upwardly deviated distance from the X-axis of the image 80. Moreover, such a DLP apparatus having a comparatively large deviation is not practical to be applied to a rear projection TV (RPTV).

### SUMMARY OF THE INVENTION

In view of the above, the object of the present invention is to provide a DLP apparatus for reducing the problem of deviation of the image in a conventional DLP apparatus.

According to the above and other objects, a DLP apparatus including an illumination system, a projection lens and a DMD is provided. The illumination system is adapted for providing an elliptic light beam; the projection lens and the DMD are secured on an optical path of the elliptic light beam; and the DMD is disposed between the illumination system and the projection lens. The DMD has a plurality of micro-mirrors, and each of the micro-mirrors is adapted for swinging within an angle of ±θ for allowing the elliptic light beam moving along with an extending direction of a short axis. Further, when the elliptic light beam is transmitted to the projection lens, a length of the long axis of the elliptic light beam is larger than a value M and a length of the short axis of the elliptic light beam is smaller than the value M, wherein the value M is an aperture diameter corresponding to f-number of the aperture being ½sin θ. The foregoing θ for example is 10 degrees or 12 degrees. The light source is adapted for providing an ordinary light beam, and the elliptic light beam generator is disposed on the optical path of the ordinary light beam for converting the ordinary light beam into the elliptic light beam.

According to the present invented DLP apparatus, the illumination system is adapted for providing an elliptic light beam. The length of the short axis of the elliptic light beam is smaller than the diameter of a conventional round light beam when the elliptic light beam is transmitted to the projection lens. As a result, without cross-interference of a light beam incident to the DMD and a reflected light beam reflected by the DMD to the projection lens, the projection lens can be moved for shortening the distance between the projection lens and the relay lens so as to reduce the deviation of the image or even lower to zero.

### BRIEF DESCRIPTION OF THE DRAWINGS

FIG. 1 is a schematic structural diagram illustrating a conventional DLP apparatus.

FIG. 2 is a diagram illustrating the position relationship of a round light beam of a micro-mirror of the conventional DMD respectively at different statuses.

FIG. 3 is schematic diagram illustrating a deviation of the image of a conventional DLP apparatus.

FIG. 4A is a schematic structural diagram illustrating a DLP apparatus according to an embodiment of the present invention.

FIG. 4B is a cross-sectional view taken along the line I-I′ of FIG. 4A.

FIG. 4C is a schematic diagram illustrating a micro-mirror of the DMD in a swinging situation.

FIG. 5 is a diagram illustrating a position relationship of an elliptic light beam of a micro-mirror of the DMD respectively at different statuses according to an embodiment of the invention.

FIG. 6 is a schematic structural diagram illustrating a DLP apparatus according to another embodiment of the present invention.

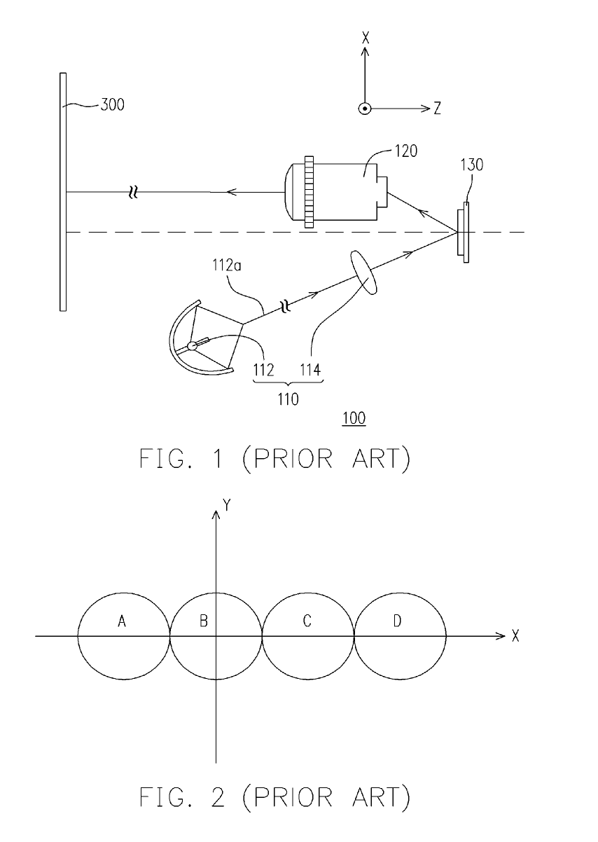

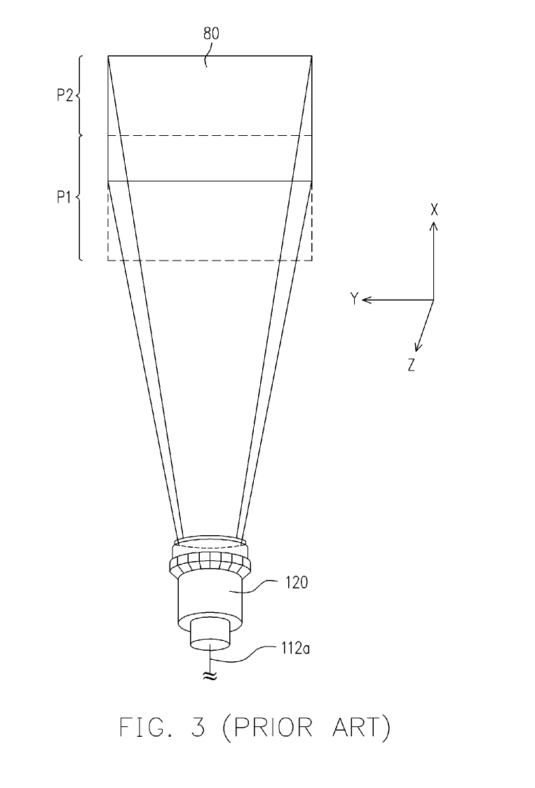

### DESCRIPTION OF THE EMBODIMENTS

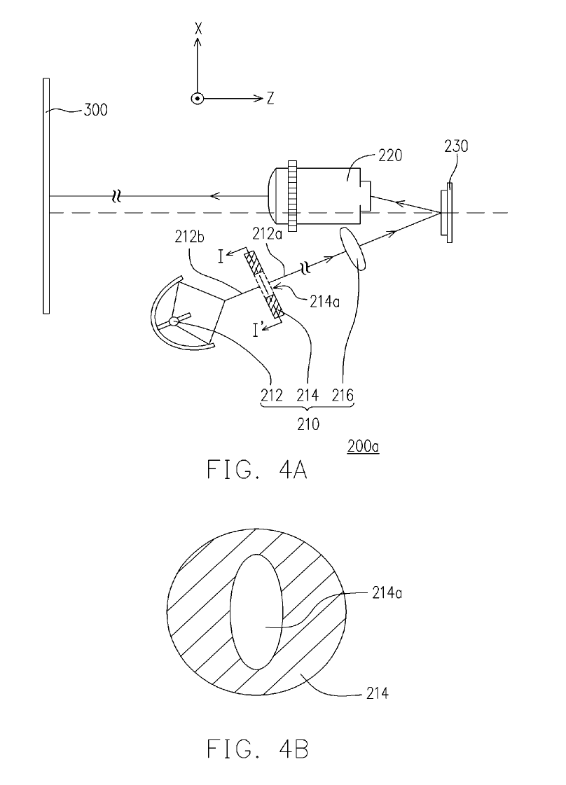

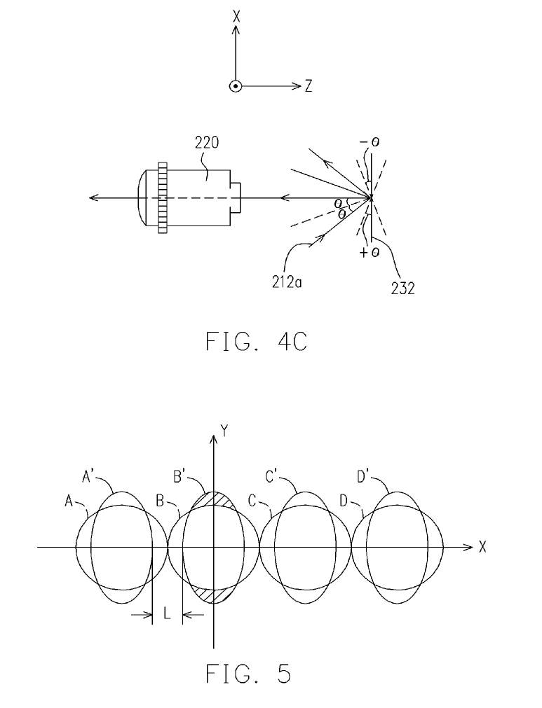

Referring to FIGS. 4A to 4C, a DLP apparatus 200a according to an embodiment of the present invention includes an illumination system 210, a projection lens 220 and a DMD 230. The illumination system 210 is adapted for providing an elliptic light beam 212a. The projection lens 220 and the DMD 230 are secured on the optical path of the round light beam 212a, and the DMD 230 is disposed between the illumination system 210 and the projection lens 220. The DMD 230 has a plurality of micro-mirrors 232 (only one shown in FIG. 4C). Each of the micro-mirrors 232 is adapted for swinging within an angle of ±θ for allowing the elliptic light beam 212a moving along with the extending direction of a short axis. Further, when the elliptic light beam 212a is transmitted to the projection lens 230, a length of the long axis of the elliptic light beam 212a is larger than a value M and a length of the short axis of the elliptic light beam is smaller than the value M, wherein the value M is an aperture diameter corresponding to f-number of the aperture being ½ sin θ.

According to the foregoing DLP apparatus 200a, the illumination system 210 for example includes a light source 212 and an elliptic light beam generator 214. The light source 212 is adapted for providing an ordinary light beam 212b, and the elliptic light beam generator 214 is disposed on the optical path of the elliptic light beam 212b. The elliptic light beam generator 214 in FIG. 4A for example is a light sheltering means having an elliptic aperture 214a for converting the ordinary light beam 212b into the elliptic light beam 212a. Then, the elliptic light beam 212a for example is transmitted to a relay lens 216 of the illumination system 210. The relay lens 216 further transmits the elliptic light beam 212a to a DMD 230. It is noted that there can be some other components such as a color wheel, an optical integration rod, a focusing lens etc. (not shown in FIG. 4A) being passed through while transmitting the elliptic light beam 212a to the relay lens 216.

The micro-mirrors of the foregoing DMD 230 are respectively at ON status (swinging at an angle of+θ) or OFF status (swinging at an angle of −θ). Those micro-mirrors 232 at ON status transmit the elliptic light beam 212a to the projection lens 220, and those micro-mirrors 232 at OFF status make the elliptic light beam 212a deviated from the projection lens 220. The part of the elliptic light beam 212a is reflected by the DMD 230 to the projection lens 220 and projects an image on a screen 300 through the projection lens 220.

According to the embodiment of the invention, the aperture (not shown) of the projection lens 220 is large enough to cover the elliptic light beam 212a that the image projected on the screen 300 has higher brightness. Wherein, the aperture can be a round shape or an elliptic shape.

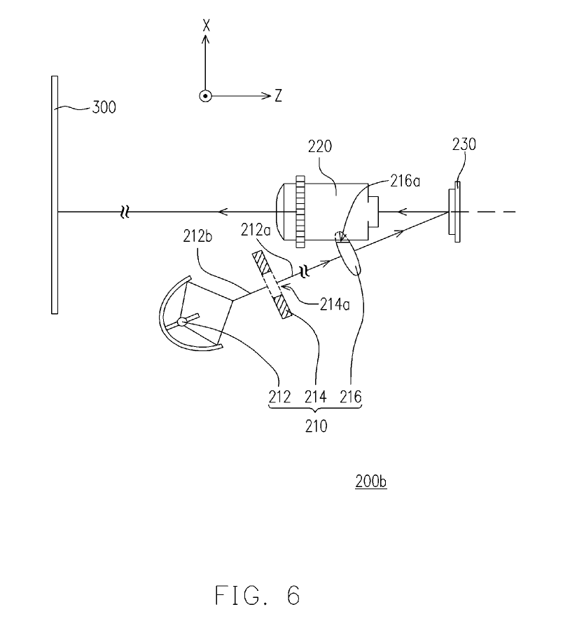

Referring to FIG. 5, A′ is an elliptic incident light beam to the DMD 230; B′ is an elliptic light beam at ON status; D′ is an elliptic light beam at FLAT status; and D′ is an elliptic light beam at OFF status. According to an embodiment, the foregoing θ for example is 10 degree, 12 degree or other degree. For instance, when θ is 12 degree, the value M is equal to the aperture diameter corresponding to f-number of the aperture is 2.4, while the diameter of a conventional round light beam A is also equal to the value M. In other words, the length of the long axis of the elliptic light beam A′ is larger than the diameter of the conventional round light beam A, and the length of the short axis of the elliptic light beam is smaller than the diameter of the conventional round light beam A.

The length of the short axis of the elliptic light beam A′ is smaller than the diameter of a round light beam A, therefore there is a distance L between the elliptic light beams A′ and B′. The elliptic light beam B′ moves downward along the Y axis without being partially overlapped with the elliptic light beam A′. As a result, the DLP apparatus 200a according to the embodiment of the present invention can move the projection lens 220 to be close to the relay lens 216 for solving the problem of a deviation of the image of the conventional DLP apparatus 100 (as shown in FIG. 1). Moreover, the DLP apparatus 200a according to the embodiment even is applied in an RPTV.

Further, comparing with the conventional round light beam B, the elliptic light beam B′ has extra areas at two sides of the long axis for compensating the reduced areas at two sides of the short axis, by which the brightness of the image can be sustained. Also, because the distance between the projection lens 220 and the relay lens 216 is shortened, an overall volume of the DLP apparatus 200a according to the embodiment of the invention can be reduced.

Referring to FIG. 6, FIG. 6 is similar with FIG. 4A except that one side of the relay lens 216 which is adjacent to the projection lens 220 forms an indentation 216a for allowing the projection lens 220 moving further downward so as to further reduce the deviation of the image even to zero. Also, since the elliptic light beam 212a does not transmit through an indentation 216a, a displaying quality is not affected.

It is to be noted that the elliptic light beam generators 214 shown in FIGS. 4A and 6 are exemplary only and should not be used to limit the invention. The elliptic light beam generator 214 also can be a taper light integration rod provided by Texas Instruments Incorporated (U.S.A.) or an optical component having an asymmetric curving surface provided by TW Patent 508474 or other optical components adapted for providing an elliptic light beam. The optical component having an asymmetric curving surface for example can be a lens or a reflective mirror. Also, the relay lenses 216 shown in FIGS. 4A and 6 can also be relay lenses having asymmetric curving surfaces.

In view of the above, the DLP apparatus of the present invention has at least the following advantages:

According to the present invented DLP apparatus, the illumination system is adapted for providing an elliptic light beam, wherein the projection lens can be moved for shortening the distance between the projection lens and the relay lens for reducing down the deviation of the image even to zero without having affected the contrast and brightness of images.

The DLP apparatus of the present invention can be applied in a rear projection TV (RPTV).

The distance between the projection lens and the relay lens is shortened, the overall volume of the DLP apparatus according to the embodiment of the invention can be reduced.

It should be noted that specific embodiments of, and examples for, the invention are described herein for illustrative purposes, various equivalent modifications are possible within the scope of the invention, as those skilled in the relevant art will recognize that modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A digital light processing (DLP) apparatus, comprising:
an illumination system, being adapted for providing an elliptic light beam;
a projection lens, being secured on an optical path of the elliptic light beam; and
a digital micro-mirror device (DMD), being disposed between the illumination system and the projection lens and secured on the optical path of the elliptic light beam, wherein the DMD has a plurality of micro-mirrors, each of the micro-mirrors being adapted for swinging within an angle of ±θ for allowing the elliptic light beam moving along with an extending direction of a short axis of the elliptic light beam, wherein when the elliptic light beam is transmitted to the projection lens, a length of a long axis of the elliptic light beam is larger than a value M and a length of the short axis of the elliptic light beam is smaller than the value M, wherein the value M is a diameter of an aperture corresponding to f-number of the aperture being ½ sin θ.

2. The DLP apparatus according to claim 1, wherein the angle θ is 10 degrees or 12 degrees.

3. The DLP apparatus according to claim 1, wherein the illumination system comprises:
a light source, being adapted for providing an ordinary light beam; and
an elliptic light beam generator, being disposed on the optical path of the ordinary light beam for converting the ordinary light beam into the elliptic light beam.

4. The DLP apparatus according to claim 3, wherein the elliptic light beam generator comprises a light sheltering means having an elliptic aperture for converting the ordinary light beam into the elliptic light beam.

5. The DLP apparatus according to claim 3, wherein the elliptic light beam generator comprises a taper light integration rod.

6. The DLP apparatus according to claim 3, wherein the elliptic light beam generator comprises an optical component having an asymmetric curving surface.

7. The DLP apparatus according to claim 6, wherein the optical component comprises a lens or a reflective mirror.

8. The DLP apparatus according to claim 3, wherein the elliptic light beam generator comprises a relay lens, being adapted for transmitting the elliptic light beam to the DMD.

9. The DLP apparatus according to claim 8, wherein the relay lens further comprises an indentation being adjacent to the projection lens.

10. The DLP apparatus according to claim 1, wherein the illumination system comprises a relay lens, being adapted for transmitting the elliptic light beam to the DMD.

11. The DLP apparatus according to claim 10, wherein the relay lens further comprises an indentation being adjacent to the projection lens.

12. The DLP apparatus according to claim 1, wherein the aperture of the projection lens covers the elliptic light beam.

13. The DLP apparatus according to claim 12, wherein the aperture is either round shaped or elliptic shaped.
